(19) United States
(12) Patent Application Publication
(10) Pub. No.: US 2024/0088377 A1
(43) Pub. Date: Mar. 14, 2024

(54) POSITIVE ELECTRODE ACTIVE MATERIAL PARTICLE, MANUFACTURING METHOD OF POSITIVE ELECTRODE ACTIVE MATERIAL PARTICLE, AND LITHIUM ION SECONDARY BATTERY

(71) Applicant: TOYOTA JIDOSHA KABUSHIKI KAISHA, Toyota-shi Aichi-ken (JP)

(72) Inventors: Yosuke Tokuda, Susono-shi Shizuoka-ken (JP); Issei Sugiyama, Susono-shi Shizuoka-ken (JP); Takeru Sawai, Susono-shi Shizuoka-ken (JP)

(73) Assignee: TOYOTA JIDOSHA KABUSHIKI KAISHA, Toyota-shi Aichi-ken (JP)

(21) Appl. No.: 18/242,563

(22) Filed: Sep. 6, 2023

(30) Foreign Application Priority Data
Sep. 8, 2022 (JP) 2022-143116

(51) Int. Cl. H01M 4/525; H01M 4/04; H01M 4/505; H01M 10/0525

(52) U.S. Cl. CPC H01M 4/525; H01M 4/049; H01M 4/505; H01M 10/0525; H01M 2004/028

(57) ABSTRACT

Disclosed are positive electrode active material particles having both high-capacity and cycling properties. The positive electrode active material particles of the present disclosure have an O2-type structure, and comprise: at least one element selected from Mn, Ni and Co; Li; an element M; and O, wherein the element M is at least one selected from B, Mg, Al, K, Ca, Ti, V, Cr, Fe, Cu, Zn, Ga, Ge, Sr, Y, Zr, Nb, Mo and W, and the molar concentration of the element M in the surface layer portion of the particles is higher than the molar concentration of the element M in the central portion of the particles.

### CROSS-REFERENCE TO RELATED APPLICATION

This application claims priority to Japanese Patent Application No. 2022-143116 filed on Sep. 8, 2022, the entire contents of which are herein incorporated by reference.

### FIELD

The present application discloses positive electrode active material particles, a manufacturing method of the positive electrode active material particles, and a lithium ion secondary battery.

### BACKGROUND

Positive electrode active materials having an O2-type structure are known. A positive electrode active material with an O2-type structure can be obtained by ion-exchange of Li for at least a portion of the Na in a Na-containing transition metal oxide with a P2-type structure, as disclosed in PTL 1.

### CITATION LIST

### Patent Literature

[PTL 1] Japanese Unexamined Patent Publication No. 2014-186937

### SUMMARY

### Technical Problem

Conventional positive electrode active materials having O2 type structures have room for improvement in terms of achieving both high-capacity and cycling properties.

### Solution to Problem

The present application discloses the following aspects as technique for solving this problem.

### <Aspect 1>

Positive electrode active material particles,
having an O2-type structure,
comprising: at least one element selected from Mn, Ni and Co; Li; an element M; and O,
wherein
the element M is at least one selected from B, Mg, Al, K, Ca, Ti, V, Cr, Fe, Cu, Zn, Ga, Ge, Sr, Y, Zr, Nb, Mo and W, and
the molar concentration of the element M in the surface layer portion of the particles is higher than the molar concentration of the element M in the central portion of the particles.

### <Aspect 2>

The positive electrode active material particles according to aspect 1, wherein
the chemical composition of the entire particles is represented by LiₐNa_{b}Mnₓ₋ₚNi_{y-q}Co_{z-r}M_{p+q+r}O₂ (wherein 0<a≤1.00, 0≤b≤0.20, x+y+z=1, and 0<p+q+r≤0.07).

### <Aspect 3>

The positive electrode active material particles according to aspect 2, wherein
the chemical composition of the surface layer portion is represented by LiₐNa_{b}Mnₓ₋ₛNi_{y-t}Co_{z-u}Mₛ₊ₜ₊ᵤO₂ (wherein 0<a≤1.00, 0≤b≤0.20, x+y+z=1, and 0.08<s+t+u).

### <Aspect 4>

The positive electrode active material particles according to aspect 2 or 3, wherein
the chemical composition of the central portion is represented by LiₐNa_{b}Mnₓ₋ₕNi_{y-i}Co_{z-j}Mₕ₊ᵢ₊ⱼO₂ (wherein 0<a≤1.00, 0≤b≤0.20, x+y+z=1, and 0≤h+i+j<0.07).

### <Aspect 5>

A manufacturing method of positive electrode active material particles, the method comprising:
obtaining Na containing transition-metal oxide particles having a P2 type structure; and
ion-exchanging at least a portion of Na of the Na containing transition metal oxide particles to Li, and doping at least one element M selected from B, Mg, Al, K, Ca, Ti, V, Cr, Fe, Cu, Zn, Ga, Ge, Sr, Y, Zr, Nb, Mo and W in the surface layer of the particle to obtain a Li containing transition-metal oxide particles having a O2 type structure,

### <Aspect 6>

The manufacturing method according to aspect 5, the method comprising:
ion-exchanging at least a portion of Na of the Na containing transition-metal oxide particles to Li, and doping the element M in the surface layer of the particle, by contacting the particle with the salt containing Li and the element M.

### <Aspect 7>

The manufacturing method according to aspect 6, wherein
the salt comprises Li, the element M and halogen.

### <Aspect 8>

The manufacturing method according to any one of aspects 5 to 7, wherein
the Na containing transition-metal oxide particles have a chemical composition shown as Na_{c}MnₓNi_{y}Co_{z}O₂ (wherein 0<c≤1.00 and x+y+z=1).

### <Aspect 9>

A lithium-ion secondary battery, comprising a positive electrode, an electrolyte layer and a negative electrode, wherein
the positive electrode includes the positive electrode active material particles according to any one of aspects 1 to 4.

### Effects

The positive electrode active material particles of the present disclosure easily achieve both high capacity and cycle characteristics.

### BRIEF DESCRIPTION OF DRAWINGS

FIG. 1 shows schematically the surface layer portion and the central portion of the positive electrode active material particles.

FIG. 2 shows an example of a flow of a manufacturing method of the positive electrode active material particles.

FIG. 3 shows schematically an example of the configuration of the lithium ion secondary battery.

FIG. 4 shows X-ray diffraction measurement results of the positive electrode active material particles according to Examples 1, 2 and Comparative Examples 1 and 2.

FIG. 5 shows an EDX element map for Al when observing the cross section of the positive electrode active material particles according to Example 1.

FIG. 6 shows an EDX element map for Al when observing the cross section of the positive electrode active material particles according to Comparative Example 2.

FIG. 7 show an example of Al concentration distribution from one surface of the particles through the center to the other surface in the EDX element map for Al when observing the cross section of the positive electrode active material particles according to Example 1.

### DESCRIPTION OF EMBODIMENTS

### 1. Background

A positive electrode active material having a O2 type structure has stability in a high potential range as compared with a conventional positive electrode active material (e.g., a positive electrode active material having a O3 type structure), and a large capacity can be obtained by utilizing charge and discharge in a high potential range. However, according to a new finding of the present inventor, a capacity deterioration when a positive electrode active material having a O2 type structure is utilized to a high potential of 4.7V (vs. Li/Li⁺) or more is larger than a capacity deterioration when used at a conventional upper limit potential (e.g., 4.4V (vs. Li/Li⁺)). Specifically, when a positive electrode active material having a O2 type structure is charged to a high potential of 4.7V (vs. Li/Li⁺) or more, Li existing between certain oxygens in O2 type structure is lost, and a O2 type structure is destabilized, which leads to a capacity degradation.

In order to stabilize O2 type structure, it is considered to be efficient to dope an element M such as Al in O2 type structure. However, the element M has a small contribution to charge and discharge, resulting in a decrease in charge and discharge capacity. In order to solve this, it is considered effective to thicken (be concentrated) the element M in the surface layer portion of the particles. Since the positive electrode active material particles release Li in order from the surface layer portion of the particles during charging, O2 type structure is easily destabilized due to a lack of Li in the surface layer portion of the particles. So, the preference for stabilizing O2 type structure is considered to be higher in the surface layer portion of the particles than in the center portion of the particles. Also, if O2 type structure can be stabilized in the surface layer portion of the particles, the effect is considered to extend to the center portion.

However, in the prior art, it has been difficult to thicken the element M in the surface layer portion of the positive electrode active material particles having a O2 type structure. This is due to the restriction of the manufacturing process of O2 type positive electrode active material particles. That is, in order to produce a positive electrode active material having a O2 type structure, as disclosed in Patent Document 1, it is required to first synthesize a Na containing transition-metal oxide having P2 type structure, and then ion-exchange Na to Li to obtain a Li containing transition-metal oxide having O2 type structure. On the other hand, when it is desired to thicken a dope element in a surface layer portion of a positive electrode active material, it is common to form a core-shell structure of a shell in which a dope element is concentrated and a core in which a dope element is dilute. Usually, a core-shell structure of a positive electrode active material is formed during precursor synthesis or firing. Therefore, in the prior art, it has been considered that, in order to obtain a O2 type active material having a core-shell structure, a core-shell structure must be formed when a Na containing transition-metal oxide having a P2 type structure is obtained. However, according to the new findings of the present inventor, in such a conventional method, the element diffuses from the surface layer portion of the particles to the central portion, and from the central portion of the particles to the surface layer portion, by diffusion of the element accompanied by heating at the time of firing to obtain a P2 type structure, diffusion of the element accompanied by a structural phase transition at the time of ion exchange, and diffusion of the element accompanied by heating at the time of ion exchange, so that it is difficult to thicken the doped element in the particle surface layer portion.

In view of the above, the present inventors have intensively studied a method of thickening an element M in a surface layer portion of a positive electrode active material particle having a O2 type structure, and have found that an element M can be appropriately thickened (be concentrated) in a surface layer portion of the Li containing transition-metal oxide particles having O2 type structure by obtaining a Na containing transition-metal oxide particles having a P2 type structure, and thereafter doping the element M when Na is ion-exchanged into Li. Further, it was also confirmed that the positive electrode active material particles thus produced are stable in O2 type structure even when they are utilized to a high potential of, for example, 4.7V (vs. Li/Li⁺) or higher, and that they hardly cause a decrease in capacity and easily achieve both a high capacity and a cycling characteristic. Hereinafter, positive electrode active material particles and a method of manufacturing the same according to an embodiment, and a lithium ion secondary battery or the like using the positive electrode active material particles will be described.

### 2. Positive Electrode Active Material Particles

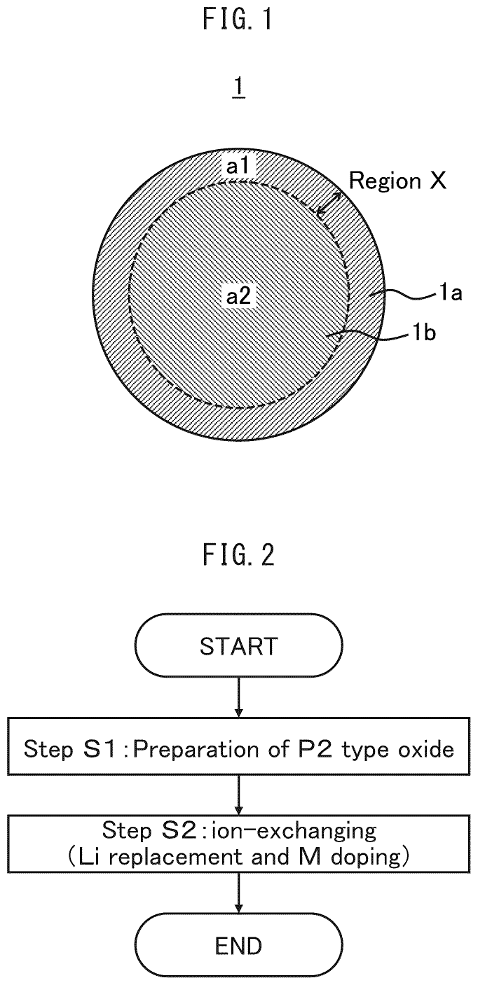

With reference to FIG. 1, a description will be given of the positive electrode active material particles 1 according to an embodiment. The positive electrode active material particles 1 have a O2 type structure. Further, the positive electrode active material particles 1 include: at least one element selected from Mn, Ni and Co; Li; an element M; and O. Here, the element M is at least one selected from B, Mg, Al, K, Ca, Ti, V, Cr, Fe, Cu, Zn, Ga, Ge, Sr, Y, Zr, Nb, Mo and W. In the positive electrode active material particles 1, the molar concentration of the element M in the surface layer portion 1a of the particles is higher than the molar concentration of the element M in the central portion 1b of the particles.

### 2.1 Surface Layer Portion and Central Portion

In the present application, as shown in FIG. 1, the positive electrode active material particles 1 divided into a surface layer portion 1a and a central portion 1b will be described. The surface layer portion 1a of the positive electrode active material particles 1 refers to a portion from the particle surface to a predetermined depth, and the central portion 1b refers to a portion deeper than the surface layer portion 1a in the particles. The depth (thickness) of the surface layer portion 1a is not particularly limited. In the present application, the “surface layer portion” and the “central portion” of the positive electrode active material particles may be specified as follows, for example. That is, when the element analysis of the cross section is performed while observing the cross section of the positive electrode active material by scanning electron microscopy (SEM), transmission electron microscopy (TEM), or the like, and when the core-shell structure of the shell in which the element M is concentrated and the core in which the element M is dilute can be confirmed, the shell is regarded as a “surface layer portion”, and the core is regarded as a “central portion”. On the other hand, when a clear core-shell structure is not confirmed for the concentration distribution of the element M, the surface layer portion and the central portion are distinguished as follows. That is, as shown in FIG. 1, a cross section of the positive electrode active material particles is observed by a scanning electron microscope (SEM), a transmission electron microscope (TEM), or the like, and a 2 dimensional image of a cross section of the positive electrode active material particles is acquired, and when the area of the region X from the surface of the positive electrode active material particles to a predetermined depth in the 2 dimensional image is taken as “a1” and the area of the entire particle is taken as “a1+a2”, a region X where a1/(a1+a2) becomes 0.1 is regarded as a “surface layer portion of the positive electrode active material particles”. It is possible to determine whether or not the molar concentration of the element M in the surface layer portion is higher than the molar concentration of the element M in the central portion by performing elemental analysis in the particle cross section with respect to each of the “surface layer portion of the positive electrode active material particles” specified in the above manner and the “central portion of the positive electrode active material particles” which is deeper than the surface layer portion (a portion on the central side).

### 2.2 Crystal Structure

The positive electrode active material particles 1 have at least a O2 type structure (belonging to the space group P63mc) as a crystalline structure. The positive electrode active material particles 1 may have a O2 type structure and a crystalline structure other than a O2 type structure. Examples of the crystal structure other than O2 type structure include T #2 type structure (belonging to a space group Cmca) and O6 type structure (belonging to a space group R-3m, and differing from a O3 type structure having a c-axis length of 2.5 nm or more and 3.5 nm or less, typically 2.9 nm or more, and also belonging to a space group R-3m), and the like formed when Li is de-inserted from O2 type structure. The positive electrode active material particles 1 may have a O2 type structure as a main phase or a crystal structure other than a O2 type structure as a main phase, but in some embodiments, those having a O2 type structure as a main phase are used. The positive electrode active material particles 1 may be those in which the crystal structure serving as a main phase changes depending on the charge and discharge state thereof.

### 2.3 Chemical Composition

The positive electrode active material particles 1 include: at least one element selected from Mn, Ni and Co; Li; an element M; and O as constituent elements. In particular, when containing as a constituent element, at least: Mn; at least one of Ni and Co; Li; an element M; and O, especially when containing as a constituent element, at least, Mn, Ni, Co, Li, an element M and O, higher performance is easily ensured. However, in the positive electrode active material particles 1, for example, Li may be almost completely released by charging, the molarity of Li may be close to 0 to the limit. Further, the positive electrode active material particles 1 may contain Na as a constituent element due to a manufacturing process described later. Furthermore, the positive electrode active material particles 1 may contain other impurity elements.

In the positive electrode active material particles 1, a predetermined element M is contained, so that O2 type structure can be stabilized. Specifically, since the element M whose valence is difficult to change is contained in the positive electrode active material particles 1, even when Li is released from the positive electrode active material particles 1 by charging, Li⁺ tends to remain around the element M, thereby stabilizing O2 type structure. The element M is at least one selected from B, Mg, Al, K, Ca, Ti, V, Cr, Fe, Cu, Zn, Ga, Ge, Sr, Y, Zr, Nb, Mo and W. Among them, when the positive electrode active material particles 1 contain at least one selected from Al, Ga, Mg, Ti, Cr, Nb and Mo as the element M, and especially, when at least one of Al and Ga is contained, more particularly when Al is contained, O2 type structure is more easily stabilized. In addition, when Al or Ga is adopted as the element M, it is also possible to greatly reduce the ion-exchange temperature (Li replacement temperature and element M doping temperature) in the step S2 in the manufacturing method described later.

In the positive electrode active material particles having a O2 type structure, it is considered that the higher the molarity of the element M, the more O2 type structure can be stabilized. On the other hand, since the element M has a small contribution to charge and discharge, it is considered that the lower the molar concentration of the element M, the more the charge and discharge capacity can be improved. In this regard, in the positive electrode active material particles 1 of the present disclosure, the element M is concentrated on the surface layer portion 1a of the particles in order to suppress the decrease in the charge and discharge capacity due to the element M while ensuring the stabilizing effect of O2 type structure by the element M. In other words, in the positive electrode active material particles 1 of the present disclosure, the molar concentration of the element M in the surface layer portion 1a of the particles is higher than the molar concentration of the element M in the central portion 1b of the particles. As described above, according to the positive electrode active material particles 1, the stabilizing effect of O2 type structure is secured by thickening (concentrating) the element M in the surface layer portion 1a, and also, a high charge/discharge capacity is secured by lowering the amount of the element M in the central portion 1b.

In the present application, “molar concentration of element M in the surface layer portion of the particles” means “average molar concentration” of element M contained in the surface layer portion of the particles, and “molar concentration of element M in the central portion of the particles” means “average molar concentration” of element M contained in the central portion of the particles. That is, in the positive electrode active material particles 1, as the “average molar concentration” of each of the surface layer portion 1a and the central portion 1b, the molar concentration of the element M in the surface layer portion 1a may be higher than the molar concentration of the element M in the central portion 1b, and the dispersion state of the element M in each of the surface layer portion 1a and the central portion 1b is not particularly limited. In other words, in the surface layer portion 1a, the element M may be uniformly dispersed or may be unevenly dispersed. In addition, in the central portion 1b, the element M may be uniformly dispersed, or may be unevenly dispersed, or the element M may not be present. Furthermore, in the positive electrode active material particles 1, the molar concentration of the element M may be continuously changed from the surface of the particles toward the center, or may be intermittently changed, or may be irregularly changed. In particular, when the positive electrode active material particles 1 have a core-shell structure of the surface layer portion 1a as a shell in which the element M is relatively concentrated, and the central portion 1b as a core having a relatively small or substantially free of element M, it is easy to obtain higher effects.

The positive electrode active material particles 1 include: at least one element selected from Mn, Ni and Co; Li; an element M; and O. The composition ratio of each element is not particularly limited as long as O2 type structure can be maintained. The positive electrode active material particles 1 may take various chemical compositions. Hereinafter, an example of a chemical composition will be described.

The chemical composition of the positive electrode active material particles 1 as a whole (average chemical composition of the entire particles) may be represented by LiₐNa_{b}Mnₓ₋ₚNi_{y-q}Co_{z-r}M_{p+q+r}O₂ (wherein 0<a≤1.00, 0≤b≤0.20, x+y+z=1, and 0<p+q+r≤0.07).

In the chemical composition of the entire particles described above, “a” may be more than 0, 0.1 or more, 0.2 or more, 0.3 or more, 0.4 or more, 0.5 or more, or 0.6 or more, and may be 1.0 or less, 0.9 or less, 0.8 or less, or 0.7 or less. In addition, “b” may be 0 or more, or more than 0, and may be 0.15 or less, 0.10 or less, 0.05 or less, 0.04 or less, 0.03 or less, 0.02 or less, or 0.01 or less. Further, “x” may be 0 or more, 0.1 or more, 0.2 or more, 0.3 or more, 0.4 or more, or 0.5 or more, and may be 1.0 or less, 0.9 or less, 0.8 or less, 0.7 or less, 0.6 or less, or 0.5 or less. In addition, “y” may be 0 or more, 0.1 or more, or 0.2 or more, and may be 1.0 or less, 0.9 or less, 0.8 or less, 0.7 or less, 0.6 or less, 0.5 or less, 0.4 or less, 0.3 or less, or 0.2 or less. Further, “z” may be 0 or more, 0.1 or more, 0.2 or more, or 0.3 or more, and may be 1.0 or less, 0.9 or less, 0.8 or less, 0.7 or less, 0.6 or less, 0.5 or less, 0.4 or less, or 0.3 or less.

As described above, the element M is small contribution to charge and discharge. In this regard, in the chemical composition of the entire particles described above, when p+q+r is 0.07 or less, high charge/discharge capacity is easily secured. p+q+r may be 0.06 or less, 0.05 or less, or 0.04 or less. On the other hand, as described above, when the element M is contained, a stabilizing effect of O2 type structure is obtained. In this regard, in the chemical composition of the entire particles described above, p+q+r is more than 0, and may be 0.01 or more, 0.02 or more or 0.03 or more.

The composition of 0 is almost 2, but is not limited to 2.0 just, and is nonstoichiometric.

In addition, in the chemical composition of the entire particles of the positive electrode active material particles 1, when the valence of the element M is set to +n, a relationship of 3.0≤4 (x-p)+2 (y-q)+3 (z-r)+n (p+q+r)≤3.5 may be satisfied. This is intended to have a range in which the total valence of the metal in the positive electrode active material is close to 3.33 valence (charge neutrality when “a” is 0.67). As will be described later, a positive electrode active material having a O2 type structure passes through a Na containing transition-metal oxide having a P2 type structure at the time of synthesizing the same. In the case where the above relation is satisfied, Na composition of the oxide becomes charge-neutral within a range of 0.5 or more and 1.0 or less.

The chemical composition in the surface layer portion 1a of the positive electrode active material particles 1 (average chemical composition in the surface layer portion 1a) may be represented by LiₐNa_{b}Mnₓ₋ₛNi_{y-t}Co_{z-u}Mₛ₊ₜ₊ᵤO₂ (wherein 0<a≤1.00, 0≤b≤0.20, x+y+z=1, and 0.08<s+t+u).

In the chemical composition of the surface layer portion 1a described above, “a” may be more than 0, 0.1 or more, 0.2 or more, 0.3 or more, 0.4 or more, 0.5 or more, or 0.6 or more, and may be 1.0 or less, 0.9 or less, 0.8 or less, or 0.7 or less. In addition, “b” may be 0 or more, or more than 0, and may be 0.15 or less, 0.10 or less, 0.05 or less, 0.04 or less, 0.03 or less, 0.02 or less, or 0.01 or less. Further, “x” may be 0 or more, 0.1 or more, 0.2 or more, 0.3 or more, 0.4 or more, or 0.5 or more, and may be 1.0 or less, 0.9 or less, 0.8 or less, 0.7 or less, 0.6 or less, or 0.5 or less. In addition, “y” may be 0 or more, 0.1 or more, or 0.2 or more, and may be 1.0 or less, 0.9 or less, 0.8 or less, 0.7 or less, 0.6 or less, 0.5 or less, 0.4 or less, 0.3 or less, or 0.2 or less. Further, “z” may be 0 or more, 0.1 or more, 0.2 or more, or 0.3 or more, and may be 1.0 or less, 0.9 or less, 0.8 or less, 0.7 or less, 0.6 or less, 0.5 or less, 0.4 or less, or 0.3 or less.

As described above, in the positive electrode active material particles 1, in order to enhance the stabilizing effects of O2 type structure, the molarity of the element M in the surface layer portion 1a is increased. Specifically, when Li is released from the positive electrode active material particles by charging, an element M whose valence is difficult to change is contained, so that Li⁺ remains around the element M, which stabilizes O2 type structure. The remaining Li takes Li⁺ site closest to the element M. In order to affect the structural stabilization by the remaining Li⁺ over the entire shell portion, another remaining Li⁺ may be present up to the second proximate Li⁺ position of the remaining Li⁺. Therefore, when the element M is uniformly distributed, when another element M is present in the second close metal position of all the elements M, it is considered that the structure stabilizing effect is exhibited in the entire shell portion. Since the number of the first and second close metal position of the element M is 12, the minimum amount of s+t+u required for another element M to be present up to the second close metal position is 1/12≈0.08. In this regard, in the chemical composition of the surface layer portion 1a described above, when s+t+u is more than 0.08, it is easy to ensure a more stabilizing effect. s+t+u may be 0.09 or more or 0.10 or more. On the other hand, the stabilization effect of O2 type structure by the element M is saturated when the molarity of the element M becomes more than a certain value. In this regard, in the chemical composition of the surface 1a of the above, s+t+u may be 0.15 or less, 0.14 or less, 0.13 or less or 0.12 or less.

The composition of 0 is almost 2, but is not limited to 2.0 just, and is nonstoichiometric.

The chemical composition in the central 1b of the positive electrode active material particles 1 (average chemical composition in the central 1b) may be represented by LiₐNa_{b}Mnₓ₋ₕNi_{y-i}Co_{z-j}Mₕ₊ᵢ₊ⱼO₂ (wherein 0<a≤1.00, 0≤b≤0.20, x+y+z=1, and 0≤h+i+j<0.07).

In the chemical composition of the central portion 1b described above, “a” may be more than 0, 0.1 or more, 0.2 or more, 0.3 or more, 0.4 or more, 0.5 or more, or 0.6 or more, and may be 1.0 or less, 0.9 or less, 0.8 or less, or 0.7 or less. In addition, “b” may be 0 or more, or more than 0, and may be 0.15 or less, 0.10 or less, 0.05 or less, 0.04 or less, 0.03 or less, 0.02 or less, or 0.01 or less. Further, “x” may be 0 or more, 0.1 or more, 0.2 or more, 0.3 or more, 0.4 or more, or 0.5 or more, and may be 1.0 or less, 0.9 or less, 0.8 or less, 0.7 or less, 0.6 or less, or 0.5 or less. In addition, “y” may be 0 or more, 0.1 or more, or 0.2 or more, and may be 1.0 or less, 0.9 or less, 0.8 or less, 0.7 or less, 0.6 or less, 0.5 or less, 0.4 or less, 0.3 or less, or 0.2 or less. Further, “z” may be 0 or more, 0.1 or more, 0.2 or more, or 0.3 or more, and may be 1.0 or less, 0.9 or less, 0.8 or less, 0.7 or less, 0.6 or less, 0.5 or less, 0.4 or less, or 0.3 or less.

As described above, in the central 1b, in order to ensure a high charge-discharge capacity, the molarity of the element M is low. In this regard, in the chemical composition of the central portion 1b described above, when h+i+j is less than 0.07, a higher charge/discharge capacity is easily secured. h+i+j may be 0.06 or less, 0.05 or less, 0.04 or less, 0.03 or less, 0.02 or less, or 0.01 or less. On the other hand, as described above, even when the central portion 1b does not contain an element M, the structure of the central portion 1b is easily kept stable by the structure stabilizing effect due to the surface layer portion 1a. In this regard, in the chemical composition of the central portion 1b described above, h+i+j may be 0, may be 0 or more, or may be more than 0.

The composition of 0 is almost 2, but is not limited to 2.0 just, and is nonstoichiometric.

### 2.4 Shape of the Particles

The positive electrode active material particles 1 may be solid particles, may be hollow particles, or may be those having voids. The positive electrode active material particles 1 may be primary particles or secondary particles in which a plurality of primary particles are aggregated. In some embodiments, each of the primary particles of the positive electrode active material particles 1 has the chemical composition described above. Average particle diameter (D50) of the positive electrode active material particles may be, for example 1 nm or more, 5 nm or more, or 10 nm or more, and may be 500 μm or less, 100 μm or less, 50 μm or less, or 30 μm or less. The average particle diameter D50 as referred to in the present application is the particle diameter (median diameter) at an integrated value of 50% in the particle size distribution on a volume basis measured by a laser diffraction/scattering method.

### 3. Manufacturing Method of Positive Electrode Active Material Particles

As described above, the positive electrode active material particles 1 having a O2 type structure can be manufactured by obtaining Na containing transition-metal oxide particles having a P2 type structure, and then ion-exchanging at least a part of Na into Li and doping the element M. That is, as shown in FIG. 2, a manufacturing method of the positive electrode active material particles 1 according to an embodiment includes:
Step S1: obtaining Na containing transition-metal oxide particles having P2 Type structure; and
Step S2: ion-exchanging at least a portion of Na of the Na containing transition metal oxide particles to Li, and doping at least one element M selected from B, Mg, Al, K, Ca, Ti, V, Cr, Fe, Cu, Zn, Ga, Ge, Sr, Y, Zr, Nb, Mo and W in the surface layer of the particle, to obtain a Li containing transition-metal oxide particles having a O2 type structure.

### 3.1 Step S1

In step S1, Na containing transition-metal oxide particles having P2 type structure are obtained.

Since O2 type structure is a metastable phase, it is required to obtain a O2 type structure by once synthesizing a P2 type transition metal oxide having a similar structure and ion-exchanging at least a part of Na of Na containing transition metal oxide to Li. Therefore, in the process of the present disclosure, first, Na containing transition-metal oxide particles having P2 type structure are obtained. Na containing transition-metal oxides having P2 type structure can be synthesized by known methods. In the step S1, for example, the Na containing transition-metal oxide having P2 type structure can be synthesized by using: an ion source capable of forming a precipitate in an aqueous solution with the transition metal ion; and a transition metal source to obtain a precipitate (precursor particles), and then mixing the precipitate and a Na source to obtain a mixture, optionally shaping and pre-firing the mixture, and then performing main-firing.

In the step S1, examples of the ion source capable of forming a precipitate with the transition-metal ion include salts such as carbonates and nitrates, and sodium hydroxide, and sodium oxide. Examples of the transition metal source include salts such as nitrate, sulfate and carbonate, and hydroxides. In the step S1, a precipitate may be obtained by dropping and mixing the ion-source and the transition-metal source into each solution. At this time, various sodium compounds may be used as the base, and an aqueous ammonia solution or the like may be added to adjust the basicity. More particularly, in the step S1, a salt containing at least one transition-metal element of Mn, Ni and Co may be obtained as a precipitate. The precipitate may be, for example, at least one of carbonate, sulfate, nitrate, acetate and hydroxide. Specifically, it may be a salt represented by MeCO₃ (Me is a transition-metal element of at least one of Mn, Ni and Co), MeSO₄, Me(NO₃)₂, Me(CH₃COO)₂, or Me(OH)₂. The precipitate can be obtained by, for example, a solution method such as a coprecipitation method or a sol-gel method. Specifically, in the coprecipitation method, an aqueous solution of MeSO₄ and an aqueous solution of Na₂CO₃ may be prepared, and each aqueous solution may be added dropwise and mixed to obtain a precipitate.

In the step S1, the quantity of Na source to be mixed with respect to the precipitate may be determined by taking into account Na loss during subsequent firing. As Na source, for example, Na salts such as carbonate or sulfate or Na compounds such as sodium oxide or sodium hydroxide may be used. In the step S1, the surface of the precipitate (precursor particles) described above may be coated with the Na salt to obtain coated particles. Here, the coated particles may be obtained by coating at least a part of the surface of the above-described precursor particles with the Na salt. The coated particles may be the one obtained by coating 40 area % or more, 50 area % or more, 60 area % or more or 70 area % or more of the surface of the above-described precursor particles with the Na salt.

In the step S1, the pre-firing is performed at a temperature lower than or equal to the main firing. For example, it is possible to perform pre-firing at a temperature of 600° C. or less. The pre-firing time is not particularly limited. Alternatively, pre-firing may be omitted.

In the step S1, the main firing may be performed, for example, at a temperature of 700° C. or higher and 1100° C. or lower. In some embodiments, the main firing may be performed at a temperature of 800° C. or higher and 1000° C. or lower. If the main firing temperature is too low, Na doping is not performed, and when the main firing temperature is too high, O3 type structure rather than P2 type structure is likely to be generated. The main firing time is not particularly limited, and may be, for example, 30 minutes or more and 10 hours or less. The main firing atmosphere is not particularly limited, and may be, for example, an oxygen-containing atmosphere such as an air atmosphere or an inert gas atmosphere.

Na containing transition-metal oxide particles obtained by the step S1 include, for example, at least: at least one element among Mn, Ni and Co; Na; and O as constituent elements. In particular, when at least: Na; Mn; at least one of Ni and Co; and O are contained as constituent elements, and especially, when at least Na, Mn, Ni, Co, and O are contained as constituent elements, the performance of the positive electrode active material particles tends to be further increased. More specifically, Na containing transition-metal oxide particles obtained by the step S1 may be those having a chemical composition represented by Na_{c}MnₓNi_{y}Co_{z}O₂ (wherein 0<c≤1.00 and x+y+z=1). When Na containing transition-metal oxide particles have such a chemical composition, P2 type structure is easily maintained. In the above chemical composition, “c” may be more than 0, 0.10 or more, 0.20 or more, 0.30 or more, 0.40 or more, 0.50 or more or 0.60 or more, and may be 1.00 or less, 0.90 or less, 0.80 or less or 0.70 or less. Further, “x” may be 0 or more, 0.1 or more, 0.2 or more, 0.3 or more, 0.4 or more, or 0.5 or more, and may be 1.0 or less, 0.9 or less, 0.8 or less, 0.7 or less, 0.6 or less, or 0.5 or less. In addition, “y” may be 0 or more, 0.1 or more, or 0.2 or more, and may be 1.0 or less, 0.9 or less, 0.8 or less, 0.7 or less, 0.6 or less, 0.5 or less, 0.4 or less, 0.3 or less, or 0.2 or less. Further, “z” may be 0 or more, 0.1 or more, 0.2 or more, or 0.3 or more, and may be 1.0 or less, 0.9 or less, 0.8 or less, 0.7 or less, 0.6 or less, 0.5 or less, 0.4 or less, or 0.3 or less. The composition of 0 is almost 2, but is not limited to 2.0 just, and is nonstoichiometric.

### 3.2 Step S2

In the step S2, at least a part of Na of the Na containing transition metal oxide particles obtained as described above is ion-exchanged to Li, and the element M is doped into the surface layer of the particles to obtain Li containing transition-metal oxide particles having O2 type structure.

In the step S2, for example, at least a portion of Na of the Na containing transition-metal oxide particles is replaced with Li by ion-exchange using a lithium-salt. There are a method of using an aqueous solution containing a lithium salt and a method of using a molten salt obtained by heating and melting a lithium salt as an ion exchange method. From the viewpoint that P2 type structure is easily broken by intrusion of water, and from the viewpoint of crystallinity, in some embodiments, a method using a molten salt is used among the two methods described above. In other words, when the Na containing transition metal oxide particles having P2 type structure described above and the molten salt are mixed and then heated to a temperature equal to or higher than the melting point of the molten salt, at least a part of Na can be replaced with Li by ion-exchange. Examples of the lithium salt constituting the molten salt include lithium halide. In some embodiments, the lithium halide is at least one of lithium chloride, lithium bromide and lithium iodide.

In the step S2, the element M is doped into the particle surface layer during ion-exchange described above. For example, by bringing an aqueous solution containing an element M into contact with the above particles or bringing a molten salt obtained by heating and melting a salt containing an element M into contact with the above particles, it is possible to dope the surface layer of the above particles with an element M. From the viewpoint that P2 type structure is easily broken by intrusion of water, and from the viewpoint of crystallinity, in some embodiments, a method using a molten salt is used among the two methods described above. In other words, by mixing the Na containing transition-metal oxide particles having P2 type structure described above with the molten salt and heating the mixture to a temperature equal to or higher than the melting point of the molten salt, it is possible to dope the surface layer of the particles with the element M. Examples of the salt containing the element M constituting the molten salt include a halide of the element M.

In the step S2, at least a part of Na of the Na containing transition-metal oxide particles may be ion-exchanged into Li and the element M may be doped into a particle surface layer by contacting the above-described Na containing transition metal oxide particles with a salt containing Li and an element M. When a salt containing Li and an element M (a mixed salt of a lithium salt and a salt of an element M, or a complex salt of Li and an element M) is used, the melting point of the salt may be lowered than when a salt of a lithium salt or a salt of an element M is used alone, respectively. In particular, when a salt containing: at least one of Al and Ga as the element M; and Li is used, the melting point tends to be greatly lowered. In other words, the temperature required for melting is lowered, and the ion-exchange of Li and the doping of the element M can be performed at a low temperature. The mixing ratio of the lithium salt and the salt of the element M is not particularly limited, but when the proportion of the lithium salt is large, the melting point tends to be high. Specific examples of the salt containing Li and element M include, for example, a salt containing Li and element M and halogen (a mixed salt of lithium halide and a halide of element M, or a complex halide of Li and element M).

Temperature in the step S2 (for example, heating temperature in the case of carrying out ion-exchange by contacting the salt containing Li and the element M to the Na containing transition-metal oxide particles) may be for example, 600° C. or less, 500° C. or less, 400° C. or less, 350° C. or less, 300° C. or less, 280° C. or less, 250° C. or less, 230° C. or less, 200° C. or less, 170° C. or less, or 150° C. or less, and it may be above room temperature or 100° C. or more. If the temperature is too high, a O3 type structure which is a stable phase is easily generated rather than a O2 type structure. When an aqueous solution containing salt is used, it is considered that ion-exchange of Li and doping of element M can be performed even at room temperature. On the other hand, when a molten salt is used, ion-exchange of Li and doping of an element M are performed above the melting point of the molten salt as described above. From the viewpoint of making the time taken for the step S2 a short time, the temperature in the step S2 may be 100° C. or more.

Time in the step S2 (e.g., heating time when performing ion-exchange after contacting the salt containing Li and the element M for the Na containing transition metal oxide particles), may be adjusted such that Na of the Na containing transition metal oxide particles is mostly substituted with Li, and the element M is doped into the particle surface layer. If it is too long, the element M may diffuse to the central portion of the particles. It is to be noted that, even when the element M diffuses into the central portion of the particles, it is considered possible to ensure a difference in molar concentration of the element M between the surface layer portion and the central portion of the particles. From the viewpoint of ensuring a sufficient time for the salt containing Li and the element M to melt, the viewpoint of making the molar concentration of the element M in the central portion as low as possible, and the viewpoint of easily forming a shell in which the element M is thickened (concentrated) in the surface layer portion, and the like, the time in the step S2 may be, for example, 10 minutes or more or 60 minutes or more, and may be 12 hours or less or 6 hours or less.

The atmosphere in the step S2 is not particularly limited, and may be, for example, an oxygen containing atmosphere such as an air atmosphere or an inert gas atmosphere.

After the step S2, some post-treatment, such as cleaning, may be performed on the Li containing transition-metal oxide particles. The positive electrode active material particles produced through the above steps S1 and S2 have O2 type structure, include at least one element selected from Mn, Ni and Co; Li; elements M; and O, wherein the element M is at least one selected from B, Mg, Al, K, Ca, Ti, V, Cr, Fe, Cu, Zn, Ga, Ge, Sr, Y, Zr, Nb, Mo and W, the molar concentration of the element M in the surface layer portion of the particles is higher than the molar concentration of the element M in the central portion of the particles.

### 4. Positive Electrode

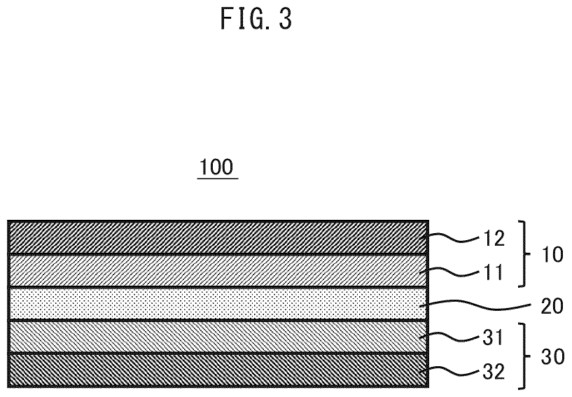

The technique of the present disclosure also has an aspect as a positive electrode. That is, the positive electrode of the present disclosure includes the positive electrode active material particles having a O2 type structure, including at least one element selected from Mn, Ni and Co; Li; an element M; and O, wherein the element M is at least one selected from B, Mg, Al, K, Ca, Ti, V, Cr, Fe, Cu, Zn, Ga, Ge, Sr, Y, Zr, Nb, Mo and W, and the molar concentration of the element M in the surface layer portion of the particles is higher than the molar concentration of the element M in the central portion of the particles. As shown in FIG. 3, the positive electrode 10 of an embodiment may include a positive electrode active material layer 11 and a positive electrode current collector 12, and in this case, the positive electrode active material layer 11 may include the above-described positive electrode active material particles 1.

### 4.1 Positive Electrode Active Material Layer

The positive electrode active material layer 11 may include at least the aforementioned positive electrode active material particles 1 as the positive electrode active material, and optionally also an electrolyte, conductive aid and binder. The positive electrode active material layer 11 may also include other additives. The contents of the positive electrode active material particles, electrolyte, conductive aid and binder in the positive electrode active material layer 11 may be determined as appropriate for the desired battery performance. For example, the content of the positive electrode active material particles may be 40 mass % or greater, 50 mass % or greater or 60 mass % or greater, and 100 mass % or lower or 90 mass % or lower, with respect to 100 mass % as the total positive electrode active material layer 11 (solid content). The form of the positive electrode active material layer 11 is not particularly restricted, and it may be a substantially flat sheet-like positive electrode active material layer 11. The thickness of the positive electrode active material layer 11 is not particularly restricted, and may be 0.1 μm or greater or 1 μm or greater, and 2 mm or smaller or 1 mm or smaller, for example.

### 4.1.1 Positive Electrode Active Material

The positive electrode active material layer 11 may include only the above-described positive electrode active material particles 1 as a positive electrode active material. Alternatively, the positive electrode active material layer 11 may include a different type of positive electrode active material (the other positive electrode active material) in addition to the positive electrode active material particles 1 described above. From the viewpoint of further enhancing the effect by the technique of the present disclosure, the content of the other positive electrode active material in the positive electrode active material layer 11 may be low. For example, the content of positive electrode active material particles 1 described above may be 50 mass % or greater, 60 mass % or greater, 70 mass % or greater, 80 mass % or greater, 90 mass % or greater, 95 mass % or greater or 99 mass % or greater, based on 100 mass % as the total amount of the positive electrode active material in the positive electrode active material layer 11.

The surface of the positive electrode active material may also be coated with a protective layer comprising a lithium ion conductive oxide. That is, the positive electrode active material layer 11 may include a complex comprising the positive electrode active material particles 1 and a protective layer formed on their surface. This will help to further inhibit reaction between the positive electrode active material particles 1 and sulfides (for example, the sulfide solid electrolytes mentioned below). Examples of lithium ion conductive oxides include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄ and Li₂WO₄. The coverage factor (area ratio) of the protective layer may be 70% or greater, 80% or greater or 90% or greater, for example. The thickness of the protective layer may be 0.1 nm or greater, or 1 nm or greater, and 100 nm or smaller or 20 nm or smaller, for example. The surface of the positive electrode active material may also be coated with a protective layer comprising a lithium ion conductive oxide. That is, the positive electrode active material layer 11 may include a complex comprising the positive electrode active material and a protective layer formed on its surface. This will help to further inhibit reaction between the positive electrode active material and sulfides (for example, the sulfide solid electrolytes mentioned below). Examples of lithium ion conductive oxides include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄ and Li₂WO₄. The coverage factor (area ratio) of the protective layer may be 70% or greater, 80% or greater or 90% or greater, for example. The thickness of the protective layer may be 0.1 nm or greater, or 1 nm or greater, and 100 nm or smaller or 20 nm or smaller, for example.

### 4.1.2 Electrolyte

The electrolyte to be optionally included in the positive electrode active material layer 11 may be a solid electrolyte, a liquid electrolyte (electrolyte solution), or a combination thereof.

The solid electrolyte used may be one that is publicly known as a solid electrolyte for lithium ion secondary batteries. The solid electrolyte may be an inorganic solid electrolyte or an organic polymer electrolyte. An inorganic solid electrolyte exhibits notably superior ionic conductivity and heat resistance. Examples of inorganic solid electrolytes include oxide solid electrolytes such as lithium lanthanum zirconate, LiPON, Li_{1+X}Al_{X}Ge_{2-X}(PO₄)₃, Li—SiO-based glass and Li—Al—S—O-based glass; and sulfide solid electrolytes such as Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅ and Li₂S—P₂S₅—GeS₂. Sulfide solid electrolytes, and especially sulfide solid electrolytes containing at least Li, S and P as constituent elements, exhibit particularly high performance. The solid electrolyte may be either amorphous or crystalline. The solid electrolyte may be particulate, for example. The solid electrolyte may be of a single type alone, or two or more different types may be used in combination.

The electrolyte solution may include lithium ion as a carrier ion, for example. The electrolyte solution may be an aqueous electrolyte solution or a nonaqueous electrolyte solution. The composition of the electrolyte solution may be a publicly known composition for lithium ion secondary battery electrolyte solutions. For example, a solution of a lithium salt at a certain concentration in a carbonate-based solvent may be used as the electrolyte solution. Examples of carbonate-based solvents include fluoroethylene carbonate (FEC), ethylene carbonate (EC) and dimethyl carbonate (DMC). Examples of lithium salts include LiPF₆.

### 4.1.3 Conductive Aid

Examples of conductive aids to be optionally added in the positive electrode active material layer 11 include carbon materials such as vapor-grown carbon fiber (VGCF), acetylene black (AB), Ketchen black (KB), carbon nanotubes (CNT) and carbon nanofibers (CNF); and metal materials such as nickel, aluminum and stainless steel. The conductive aid may be particulate or filamentous, for example, and its size is not particularly restricted. The conductive aid may be of a single type alone, or two or more different types may be used in combination.

### 4.1.4 Binder

Examples of binders to be optionally added in the positive electrode active material layer 11 include butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders and polyimide (PI)-based binders. The binder may be of a single type alone, or two or more different types may be used in combination.

### 4.2 Positive Electrode Current Collector

As shown in FIG. 3, the positive electrode 10 may comprise a positive electrode collector 12 in contact with the positive electrode active material layer 11. The positive electrode collector 12 used may be any common one used as a positive electrode collector for a battery. The positive electrode collector 12 may be used as a foil, laminar form, mesh form, punching metal or foam. The positive electrode collector 12 may also be made of a metal foil or metal mesh. A metal foil is particularly suitable in terms of handleability. The positive electrode collector 12 may also comprise a plurality of foils. The metal composing the positive electrode collector 12 may be Cu, Ni, Cr, Au, Pt, Ag, Al, Fe, Ti, Zn, Co or stainless steel. In some embodiments, from the viewpoint of ensuring oxidation resistance, the positive electrode collector 12 contains Al. The positive electrode collector 12 may also have a coating layer on the surface, in order to adjust the resistance. The positive electrode collector 12 may also have metal plated or vapor deposited on a metal foil or base. When the positive electrode collector 12 is made of a plurality of metal foils, it may also have different layers between the plurality of metal foils. The thickness of the positive electrode collector 12 is not particularly restricted. For example, it may be 0.1 μm or greater or 1 μm or greater, or 1 mm or smaller or 100 μm or smaller.

### 4.3 Other

In addition to the structure described above, the positive electrode 10 may further comprise a structure commonly used in lithium ion secondary battery positive electrodes. For example, it may have a tab or terminals. The positive electrode 10 may be produced by a publicly known method, except for the use of the positive electrode active material particles 1 as the positive electrode active material. For example, a positive electrode mixture containing the components mentioned above may be dry or wet molded to easily form a positive electrode active material layer 11. The positive electrode active material layer 11 may be formed together with the positive electrode collector 12, or it be formed separately from the positive electrode collector 12

### 5. Lithium-Ion Secondary Battery

As shown in FIG. 3, a lithium ion secondary battery 100 according to an embodiment includes a positive electrode 10, an electrolyte layer 20, and a negative electrode 30. Here, the positive electrode 10 includes the positive electrode active material particles 1 of the present disclosure described above. As described above, the positive electrode active material particles 1 are easily compatible with high charge/discharge capacity and cycle characteristics. In this regard, since the positive electrode active material particles 1 are contained in the positive electrode 10 of the lithium ion secondary battery 100, the performance of the lithium ion secondary battery 100 tends to be enhanced. A specific configuration example of the positive electrode 10 is as described above.

### 5.1 Electrolyte Layer

The electrolyte layer 20 includes at least an electrolyte. When the lithium ion secondary battery 100 is a solid-state battery (a battery with a solid electrolyte which may be used in partial combination with a liquid electrolyte, or optionally as an all-solid-state battery without a liquid electrolyte), the electrolyte layer 20 may include a solid electrolyte and optionally also a binder. In this case there is no particular restriction on the total content of the solid electrolyte and binder of the electrolyte layer 20. When the lithium ion secondary battery 100 is a liquid electrolyte battery, the electrolyte layer 20 may include a electrolyte solution and may also have a separator to hold the electrolyte solution and to prevent contact between the positive electrode active material layer 11 and the negative electrode active material layer 31. The thickness of the electrolyte layer 20 is not particularly restricted, and may be 0.1 μm or greater or 1 μm or greater, and 2 mm or smaller or 1 mm or smaller, for example.

The electrolyte in the electrolyte layer 20 may be selected as appropriate from among the aforementioned electrolytes that can be included in the positive electrode active material layer. The binder to be optionally included in the electrolyte layer 20 may also be selected as appropriate from among the aforementioned binders that can be included in the positive electrode active material layer. The electrolyte and binder may be of a single type alone, or two or more different types may be used in combination. The separator may be the one commonly used in lithium ion secondary batteries, examples of which include resins such as polyethylene (PE), polypropylene (PP), polyesters and polyamides. The separator may have a monolayer structure or a layered structure. Examples of separators with layered structures include separators with PE/PP two-layer structures, and separators with PP/PE/PP or PE/PP/PE three-layer structures. The separator may be made of a nonwoven fabric such as a cellulose nonwoven fabric, resin nonwoven fabric or glass fiber nonwoven fabric.

### 5.2 Negative Electrode

As shown in FIG. 3, the negative electrode 30 may comprise a negative electrode active material layer 31 and a negative electrode collector 32.

### 5.2.1 Negative Electrode Active Material Layer

The negative electrode active material layer 31 includes at least a negative electrode active material, and it may also optionally include an electrolyte, a conductive aid and a binder. The negative electrode active material layer 31 may also include other additives. The contents of the negative electrode active material, electrolyte, conductive aid and binder in the negative electrode active material layer 31 may be determined as appropriate for the desired battery performance. For example, the content of the negative electrode active material may be 40 mass % or greater, 50 mass % or greater or 60 mass % or greater, and 100 mass % or lower or 90 mass % or lower, with respect to 100 mass % as the total negative electrode active material layer 31 (solid content). The form of the negative electrode active material layer 31 is not particularly restricted, and it may be a substantially flat sheet-like negative electrode active material layer. The thickness of the negative electrode active material layer 31 is not particularly restricted, and may be 0.1 μm or greater or 1 μm or greater, and 2 mm or smaller or 1 mm or smaller, for example.

As the negative electrode active material, various materials whose potential for storing and releasing lithium ions (charge-discharge potential) is electronegative compared to the positive electrode active material particles 1 having O2 type structure can be employed. For example, a silicon-based active material such as Si or a Si alloy, or silicon oxide; a carbon-based active material such as graphite or hard carbon; an oxide-based active material such as lithium titanate; or lithium metal or a lithium alloy, may be used. The negative electrode active material may be of a single type alone, or two or more different types may be used in combination.

The form of the negative electrode active material may be any common form used as a negative electrode active material for a battery. The negative electrode active material may be particulate, for example. The negative electrode active material particles may be primary particles, or secondary particles which are aggregates of multiple primary particles. The mean particle diameter (D50) of the negative electrode active material particles may be 1 nm or greater, 5 nm or greater or 10 nm or greater, and 500 μm or smaller, 100 μm or smaller, 50 μm or smaller or 30 μm or smaller, for example. Alternatively, the negative electrode active material may be in a sheet (foil or film) form such as lithium foil. That is, the negative electrode active material layer 31 may be made of a sheet of the negative electrode active material.

The electrolyte to be optionally included in the negative electrode active material layer 31 may be the aforementioned solid electrolyte or electrolyte solution, or a combination thereof. The conductive aid to be optionally included in the negative electrode active material layer 31 may be any of the aforementioned carbon materials or metal materials. The binder to be optionally included in the negative electrode active material layer 31 may be selected as appropriate from among the aforementioned binders that can be included in the positive electrode active material layer 11, for example. The electrolyte, conductive aid and binder may be of a single type alone, or two or more different types may be used in combination.

### 5.2.2 Negative Electrode Current Collector

As shown in FIG. 3, the negative electrode 30 may comprise a negative electrode collector 32 in contact with the negative electrode active material layer 31. The negative electrode collector 32 used may be any common one used as a negative electrode collector for a battery. The negative electrode collector 32 may be used as a foil, laminar form, mesh form, punching metal or foam. The negative electrode collector 32 may also be a metal foil or metal mesh, or alternatively a carbon sheet. A metal foil is particularly suitable in terms of handleability. The negative electrode collector 32 may also comprise a plurality of foils or sheets. The metal composing the negative electrode collector 32 may be Cu, Ni, Cr, Au, Pt, Ag, Al, Fe, Ti, Zn, Co or stainless steel. In some embodiments, from the viewpoint of ensuring reduction resistance and inhibiting alloying with lithium, the negative electrode collector 32 includes at least one type of metal selected from among Cu, Ni and stainless steel. The negative electrode collector 32 may also have a coating layer on the surface, in order to adjust the resistance. The negative electrode collector 32 may also have a metal plated or vapor deposited on a metal foil or base. When the negative electrode collector 32 is made of a plurality of metal foils, it may also have different layers between the plurality of metal foils. The thickness of the negative electrode collector 32 is not particularly restricted. For example, it may be 0.1 μm or greater or 1 μm or greater, or 1 mm or smaller or 100 μm or smaller.

### 5.3 Other Matters

The lithium ion secondary battery 100 may have the structure described above housed inside an exterior body. The exterior body used may be any publicly known type used as an exterior body for batteries. A plurality of batteries 100 may also be optionally electrically connected and optionally stacked to form a battery assembly. In this case the assembled batteries may be housed inside publicly known battery cases. The lithium ion secondary battery 100 may also be provided with obvious structural parts such as necessary terminals and the like. Examples of forms for the lithium ion secondary battery 100 include coin, laminated, cylindrical and rectilinear battery types.

The lithium ion secondary battery 100 can be produced by a publicly known method. For example, it can be produced in the following manner. However, the method for producing the lithium ion secondary battery 100 is not limited to this method, and each of the layers may be formed by dry molding, for example.

(1) The negative electrode active material that is to form the negative electrode active material layer is dispersed in a solvent to obtain a negative electrode layer slurry. The solvent used may be, but is not limited to, water or an organic solvent. A doctor blade is used to coat the negative electrode layer slurry onto the surface of a negative electrode collector, and it is then dried to form a negative electrode active material layer on the negative electrode collector surface, obtaining a negative electrode.
(2) The positive electrode active material that is to form the positive electrode active material layer is dispersed in a solvent to obtain a positive electrode layer slurry. The solvent used may be, but is not limited to, water or an organic solvent. A doctor blade is used to coat the positive electrode layer slurry onto the surface of a positive electrode collector, and it is then dried to form a positive electrode active material layer on the positive electrode collector surface, obtaining a positive electrode.
(3) Each layer is stacked with the electrolyte layer (solid electrolyte layer or separator) sandwiched between the negative electrode and positive electrode, to obtain a stack having a negative electrode collector, negative electrode active material layer, electrolyte layer, positive electrode active material layer and positive electrode collector in that order. Terminals and other members are attached to the stack as necessary.
(4) The stack is housed in a battery case, the battery case then being filled with electrolyte solution in the case of an electrolyte battery, and the stack inside the battery case is sealed with the stack immersed in the electrolyte solution, to obtain a secondary battery. For an electrolyte battery, the electrolyte solution may be added to the negative electrode active material layer, separator and positive electrode active material layer at stage (3).

### 6. Battery System

The technique of the present disclosure also has an aspect as a system for controlling charge and discharge of a lithium ion secondary battery. That is, the battery system of the present disclosure includes a lithium ion secondary battery 100 of the present disclosure, and a control unit controlling the charging and discharging of the lithium ion secondary battery 100, wherein the control unit controls the charging of the lithium ion secondary battery 100 such that the positive electrode potential at the charging termination potential of the lithium ion secondary battery 100 is 4.7V (vs. Li/Li⁺) or more, or 4.8V (vs. Li/Li⁺) or more. As described above, even when the positive electrode active material particles 1 of the present disclosure are utilized in a high potential range, cationic mixing hardly occurs, and destabilization of O2 type structure can be suppressed. For example, the positive electrode active material particles 1 of the present disclosure can be stably charged and discharged without causing any cationic mixing even if the positive electrode reaches 4.8V (vs. Li/Li⁺) in which almost the entire amount of Li is pulled out. The control unit may be any one that can control the charging and discharging of the lithium ion secondary battery 100 as described above. When controlling the charging and discharging of the lithium ion secondary battery 100 by the control unit, the positive electrode potential at the discharge termination potential of the lithium ion secondary battery 100 is not particularly limited, and it can be determined according to the battery target performance.

### 7. A Method of Charging and Discharging a Lithium Ion Secondary Battery, a Method of Improving the Charging and Discharging Capacity of the Lithium Ion Secondary Battery, and a Method of Improving the Cycle Characteristics of the Lithium Ion Secondary Battery

The technology of the present disclosure also has an aspect as a method of charging and discharging a lithium ion secondary battery, a method of improving the charging and discharging capacity of the lithium ion secondary battery, and a method of improving the cycle characteristics of the lithium ion secondary battery. That is, the charge and discharge method of the lithium-ion secondary battery comprises: using the positive electrode active material particles in the positive electrode of the lithium-ion secondary battery; and charging and discharging the lithium-ion secondary battery, wherein charging of the lithium-ion secondary battery is controlled so that the positive electrode potential in charge termination potential is 4.7V (vs. Li/Li⁺) or more, or 4.8V (vs. Li/Li⁺) or more. In addition, a method of improving the charge and discharge capacity of the lithium-ion secondary battery of the present disclosure or a method of improving the cycle characteristics of the lithium-ion secondary battery of the present disclosure are characterized in that the positive electrode active material particles of the present disclosure described above are used in the positive electrode of the lithium-ion secondary battery.

### 8. Vehicles Having a Lithium-Ion Secondary Battery

As described above, when the positive electrode active material particles of the present disclosure are included in the positive electrode of the lithium ion secondary battery, improvement in the capacity and cycle characteristics of the lithium ion secondary battery can be expected. Such a lithium ion secondary battery having performance can be suitably used in at least one type of vehicle selected from, for example, a hybrid vehicle (HEV), a plug-in hybrid vehicle (PHEV), and an electric vehicle (BEV). In other words, the technique of the present disclosure is a vehicle having a lithium ion secondary battery, wherein the lithium ion secondary battery has a positive electrode, an electrolyte layer, and a negative electrode, and the positive electrode includes the positive electrode active material particles of the present disclosure.

### EXAMPLES

As described above, one embodiment of the positive electrode active material particles, the method of manufacturing the positive electrode active material particles, and the lithium ion secondary battery are shown, but the positive electrode active material particles, the method of manufacturing the positive electrode active material particles, and the lithium ion secondary battery of the present disclosure can be variously modified other than the above embodiments without departing from the gist thereof. Hereinafter, the technique of the present disclosure will be described in further detail with reference to Examples, but the technique of the present disclosure is not limited to the following Examples.

### 1. Preparation of Positive Electrode Active Material Particles and Coin Cell for Evaluation

### 1.1 Example 1

### 1.1.1 Precipitate (Precursor Particles) Preparation

Mn(NO₃)₂·6H₂O, Ni(NO₃)₂·6H₂O, and Co(NO₃)₂·6H₂O were dissolved in pure water so that the molar ratio of Mn, Ni and Co was 5:2:3 to obtain the first solutions. On the other hand, a second solution containing a concentrated 12 wt % of Na₂CO₃ was produced. A drop of the first solution and the second solution were simultaneously putted into a beaker. At this time, the drop speed was controlled so that pH was 7.0 or more and less than 7.1. After completion of the dropping, the mixed solutions were stirred at 50° C., 300 rpm for 24 hours. The resulting reaction product was washed with pure water and only the precipitate was separated by centrifugation. The resulting precipitate was dried at 120° C. for 48 h and then crushed in an agate mortar to obtain the precursor particles.

### 1.1.2 Fabrication of Na Containing Transition-Metal Oxide Particles Having P2 Type Structure

The precursor particles and Na₂CO₃ were mixed so as to have a composition of Na_{0.67}Mn_{0.5}Ni_{0.2}Co_{0.3}O₂ to obtain a mixed powder. The resulting mixed powder was pressed with a load of 2 tons by a cold isotropic pressure method to produce pellets. After 6 hours pre-firing of the resulting pellets at 600° C. in an air atmosphere, main firing at 900° C., 24 hours was performed to obtain a Na containing transition-metal oxide particles having a P2 type structure.

### 1.1.3 Preparation of Positive Electrode Active Material Particles

AlCl₃ and LiCl were mixed in a molar ratio of 1:1 to give a mixed salt. The obtained mixed salt and Na containing transition-metal oxide particles described above were weighed so that the amount of Li contained in the mixed salt was two times as large as the amount of Na contained in the Na containing transition-metal oxide particles. The mixed salt and the Na containing transition-metal oxide particles were mixed, and 1 hour ion-exchange was carried out at 150° C. in an air atmosphere. After ion-exchange, water was added to dissolve the salt, and water washing was further performed to obtain Li containing transition-metal oxide particles having O2 type structure. The obtained Li containing transition-metal oxide particles were crushed by a ball mill to obtain positive electrode active material particles as a target material.

### 1.1.4 Preparation of the Positive Electrode

In 125 mL of n-methylpyrrolidone solutions in which polyvinylidene fluoride (PVdF) was dissolved in 5 g, the above-mentioned positive electrode active material particle 85 g and carbon black 10 g were added and uniformly kneaded to prepare a paste. This paste was coated on a Al foil having a thickness of 15 μm on one side with a basis weight 6 mg/cm² and dried to obtain a laminate having a positive electrode mixture layer on the Al foil. Thereafter, this laminate was pressed, and the thickness of the mixture layer was 45 μm, and the density of the mixture layer was set as a 2.4 g/cm³. Finally, cut out the laminate after pressing so that φ16 mm, to obtain a positive electrode.

### 1.1.5 Preparation of the Negative Electrode

Li foil was cut out so as to be φ19 mm to obtain a negative electrode.

### 1.1.6 Making a Coin Cell

A CR2032 coin cell was prepared using the positive electrode and the negative electrode described above. Here, a porous separator made of PP was used as a separator, and a mixture of EC (ethylene carbonate) and DMC (dimethyl carbonate) as an electrolytic solution in a volume ratio of 3:7 in which lithium hexafluoride phosphoric acid (LiPF₆) was dissolved in a concentration 1 mol/L as a support salt was used as an electrolyte solution.

### 1.2 Example 2

The positive electrode active material particles, a positive electrode, a negative electrode, and a coin cell were prepared in the same manner as in Example 1, except that as a mixed salt, a mixture of GaCl₃ and LiCl in a molar ratio of 1:1 was used, and the temperature at the time of ion-exchange was 100° C.

### 1.3 Comparative Example 1

The positive electrode active material particles, a positive electrode, a negative electrode, and a coin cell were prepared in the same manner as in Example 1, except that as a mixed salt, a mixture of LiNO₃ and LiCl in a molar ratio of 88:12 was used and the temperature at the time of ion-exchange was 280° C.

### 1.4 Comparative Example 2

A positive electrode active material particles, positive electrode, a negative electrode, and a coin cell were prepared in the same manner as in Comparative Example 1, except that in preparing the precipitate (precursor particles), Mn(NO₃)₂·6H₂O, Ni(NO₃)₂·6H₂O, Co(NO₃)₂·6H₂O, and Al(NO₃)₃·9H₂O were weighed so that the molar ratio of Mn, Ni, Co and Al was 5:2:2:1, and in preparing Na containing transition-metal oxide particles having P2 type structure, the precursor particles and Na₂CO₃ were mixed so as to have a composition of Na_{0.67}Mn_{0.5}Ni_{0.2}Co_{0.2}Al_{0.1}O₂ to obtain a mixed powder.

### 1.5 Comparative Example 3

A positive electrode active material particles, positive electrode, a negative electrode, and a coin cell were prepared in the same manner as in Comparative Example 2 except that in preparing the precipitate (precursor particles), Mn(NO₃)₂·6H₂O, Ni(NO₃)₂·6H₂O, Co(NO₃)₂·6H₂O, and Al(NO₃)₃·9H₂O were weighed so that the molar ratio of Mn, Ni, Co and Al was 50:20:26:4.

### 1.6 Comparative Example 4

A positive electrode active material particles, positive electrode, a negative electrode, and a coin cell were prepared in the same matter as in Comparative Example 2 except that in preparing the precipitate (precursor particles), Mn(NO₃)₂·6H₂O, Ni(NO₃)₂·6H₂O, Co(NO₃)₂·6H₂O, and Ga(NO₃)₃·nH₂O were weighed so that the molar ratio of Mn, Ni, Co and Ga was 50:20:27:3.

### 2. Identification of the Crystalline Phase Contained in the Positive Electrode Active Material Particles

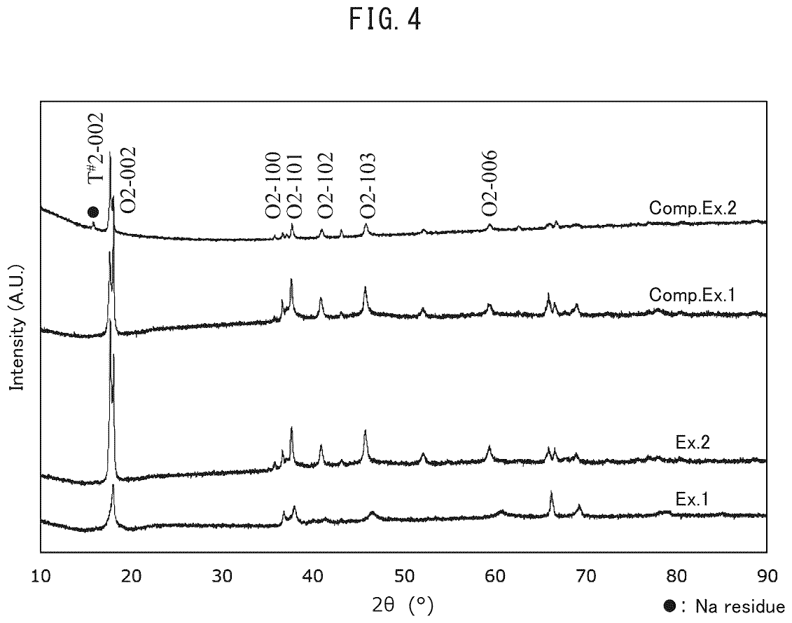

X-ray diffraction measurement was performed on each of the positive electrode active material particles according to Examples and Comparative Examples, the results are shown in FIG. 4. It can be seen from FIG. 4 that, for both of Examples 1 and 2 and Comparative Examples 1 and 2, although T #2 type structure (a structure derived from a O2 type structure depending on the amount of Li) is slightly included, it is formed only from O2 type structure and a derivative structure thereof. Although not shown, the same structure was obtained for Comparative Examples 3 and 4.

### 3. Identification of the Chemical Composition of the Positive Electrode Active Material Particles

For each of the positive electrode active material particles according to the examples and comparative examples, the mean chemical composition of the whole particles was specified by ICP-AES. The results are shown in Table 1 below. Incidentally, the composition shown in Table 1 below is normalized so that the sum of Mn, Ni, Co and element M (Al or Ga) is 1.00.

TABLE 1

| | Li | Mn | Ni | Co | Al | Ga |
|---|---|---|---|---|---|---|
| Ex. 1 | 0.68 | 0.50 | 0.20 | 0.26 | 0.04 | — |
| Ex. 2 | 0.67 | 0.50 | 0.20 | 0.27 | — | 0.03 |
| Comp. Ex. 1 | 0.68 | 0.50 | 0.20 | 0.30 | — | |
| Comp. Ex. 2 | 0.68 | 0.50 | 0.20 | 0.21 | 0.09 | — |
| Comp. Ex. 3 | 0.67 | 0.50 | 0.20 | 0.26 | 0.04 | — |
| Comp. Ex. 4 | 0.65 | 0.50 | 0.21 | 0.26 | — | 0.03 |

### 4. Observation of Distributed Morphology of Elements M (Al or Ga) in Positive Electrode Active Material Particles

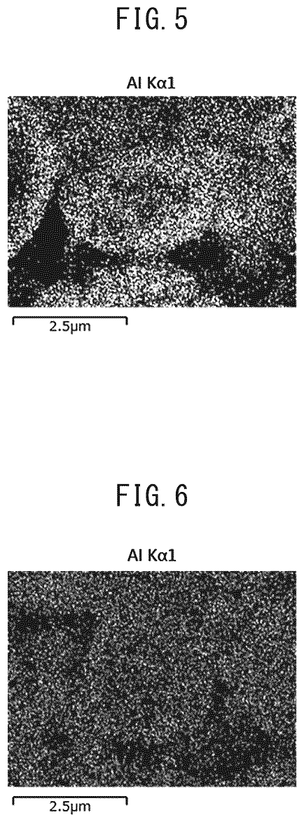

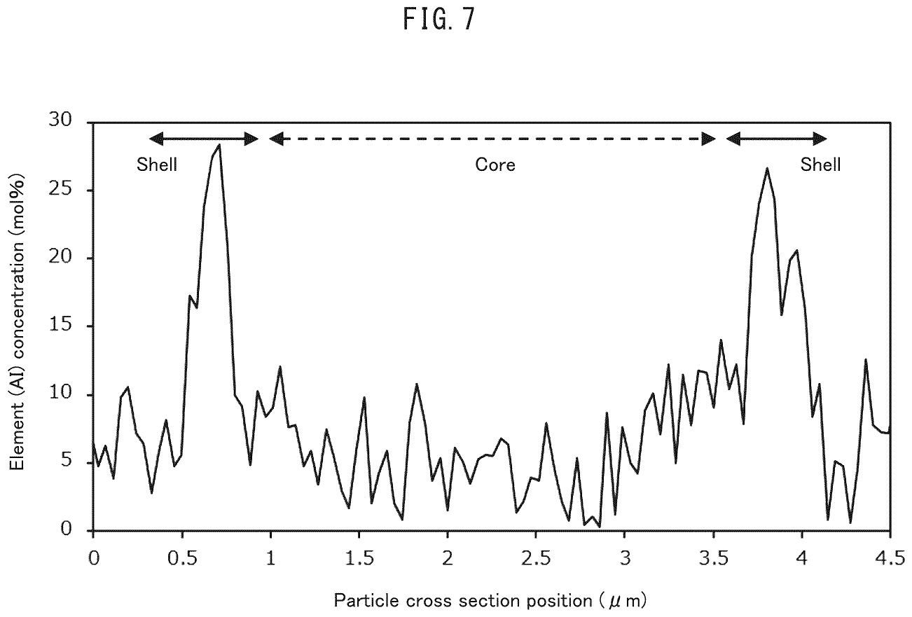

For each of the positive electrode active material particles according to Examples and Comparative Examples, the element distribution in the cross section was observed by EDX. As a result, it was found that, for the positive electrode active material particles according to Examples 1 and 2, the element M is concentrated on the particle surface layer to form a shell shape, whereas for the positive electrode active material particles according to Comparative Examples 2 to 4, the element M is uniformly present throughout the particles. For reference, FIG. 5 shows EDX element map for Al when observing the cross section of the positive electrode active material particles according to Example 1, FIG. 6 shows EDX element map for Al when observing the cross section of the positive electrode active material particles according to Comparative Example 2, respectively. Further, FIG. 7 shows an example of Al density distribution from one surface of the particle through the center to the other surface in EDX element map for Al of the cross section of the positive electrode active material particle according to Example 1. From the results shown in FIGS. 5 to 7, it can be seen that, for the positive electrode active material particles according to Example 1, the element M is concentrated in the particle surface layer portion to form a shell shape, whereas for the positive electrode active material particles according to Comparative Example 2, the element M is uniformly present throughout the particles. For each of the positive electrode active material particles according to Examples 1 and 2, the average chemical composition in the particle surface layer portion was specified, resulting in the results shown in Table 2 below. Further, for each of the positive electrode active material particles according to Examples 1 and 2, the average chemical composition in the particle center portion was specified, resulting in the results shown in Table 3 below. Note that the compositions shown in Tables 2 and 3 below are normalized so that the sum of Mn, Ni, Co and element M (Al or Ga) is 1.00 in the same manner as in Table 1. On the other hand, for the positive electrode active material particles according to Comparative Examples 1 to 4, the chemical composition of the surface layer portion of the particles and the chemical composition of the central portion were substantially the same.

TABLE 2

| | Li | Mn | Ni | Co | Al | Ga |
|---|---|---|---|---|---|---|
| Ex. 1 | 0.68 | 0.50 | 0,20 | 0.20 | 0.10 | — |
| Ex. 2 | 0.67 | 0.50 | 0.20 | 0.21 | — | 0.09 |

TABLE 3

| | Li | Mn | Ni | Co | Al | Ga |
|---|---|---|---|---|---|---|
| Ex. 1 | 0.68 | 0.50 | 0.20 | 0.30 | <0.01 | — |
| Ex. 2 | 0.67 | 0.50 | 0.20 | 0.30 | — | <0.01 |

### 5. Evaluation of Initial Discharge Capacity and Charge/Discharge Cycle Characteristics

the capacity retention rate after the first discharge capacity and 10 cycles when the charge and discharge at the charge and discharge rate of 0.1C were measured for each the coin cell. Charge and discharge was set as to 4.8V of charge and to 2.0V of discharge for any of the cycles.

### 6. Evaluation of Charge/Discharge Rate Characteristics

The prepared coin cell was charged, in a thermostatic bath held at 25° C., in the voltage-range of 2.0-4.8V, with 0.1C, then discharged with 0.1C, 0.5C, 1C or 5C, the discharge capacity at each rate was measured, it was evaluated by comparing the discharge capacity at 0.1C as 100%.

### 7. Evaluation Results

Table 4 below shows evaluation results for each of the distribution form of the element M in the active material particles, the initial discharge capacity of the coin cell, the charge and discharge cycle characteristics of the coin cell, and the charge and discharge rate characteristics of the coin cell.

TABLE 4

| | Distribution | | | | | |
|---|---|---|---|---|---|---|
| | form of the | Initial | Capacity | | | |
| | element M in | Discharge | retention rate | | | |
| | the active | capacity | after 10 cycles | Rate characteristics | | |
| | material particles | (0.1 C) | (0.1 C) | 0.5 C | 1 C | 5 C |
| Ex. 1 | Shell | 204 mAh/g | 97% | 91% | 87% | 63% |
| Ex. 2 | Shell | 194 mAh/g | 95% | 90% | 82% | 60% |
| Comp. Ex. 1 | Uniform | 218 mAh/g | 80% | 68% | 59% | 28% |
| Comp. Ex. 2 | Uniform | 181 mAh/g | 98% | 92% | 87% | 62% |
| Comp. Ex. 3 | Uniform | 197 mAh/g | 92% | 82% | 71% | 44% |
| Comp. Ex. 4 | Uniform | 186 mAh/g | 87% | 79% | 62% | 35% |

From the results shown in Tables 1 to 4, it can be seen that:

(1) Although the positive electrode active material particles according to Comparative Example 1 have high initial discharge capacity, they are inferior in cycle characteristics and rate characteristics. In Comparative Example 1, it is considered that O2 type structure is destabilized in the high potential region of 4.8V, resulting in a decrease in the cycling characteristics and the rate characteristics.
(2) Although the positive electrode active material particles according to Comparative Example 2 have cycle characteristics and rate characteristics, the initial discharge capacity is low. In Comparative Example 2, since a large amount of the element M is doped in the entire surface layer portion and the central portion of the particles, O2 type structure is stabilized. However, it is considered that when a large amount of the element M having a small contribution to charge and discharge is doped, the charge and discharge capacity is greatly reduced.
(3) The positive electrode active material particles according to Comparative Examples 3 and 4, the initial discharge capacity, the cycle characteristics and the rate characteristics neither can be said to be sufficient. Comparative Examples 3 and 4, although the element M is uniformly and a small amount doped throughout the surface layer portion and the central portion of the particles, in this case, the structure stabilizing effect by the element M in the surface layer portion is not sufficiently secured, also by uniformly doped element M to the central portion, it is considered that the charge and discharge capacity secured by the central portion is lowered.
(4) In contrast, it can be seen that the positive electrode active material particles according to Examples 1 and 2 easily achieve both high capacity and cycle characteristics as compared with the positive electrode active materials according to Comparative Examples 1 to 4 It can also be seen that the positive electrode active material particles according to Examples 1 and 2 easily ensure rate characteristics as compared with the positive electrode active materials according to Comparative Examples 1 to 4. It is considered that, in the positive electrode active material particles according to Examples 1 and 2, the element M is concentrated and present in the surface layer portion of the particles, and O2 type structure is stabilized in the surface layer portion of the particles, so that the effect extends to the central portion. In addition, it is considered that the molar concentration of the element M in the central portion of the particles is relatively lowered, and a large charge/discharge capacity is secured by the central portion.

### 8. Supplement

In the above Examples, the example having all of Mn, Ni and Co as the transition metal element, Li, element M, and O are exemplified, but the transition metal element constituting the positive electrode active material particles is not limited thereto. For example, when at least one element selected from Mn, Ni and Co; Li; an element M; and O are contained, O2 type structure is easily formed.

In addition, in the above Examples, the example in which Al or Ga is contained as the element M is exemplified, but the element M constituting the positive electrode active material particles is not limited thereto. For example, when at least one element selected from B, Mg, Al, K, Ca, Ti, V, Cr, Fe, Cu, Zn, Ga, Ge, Sr, Y, Zr, Nb, Mo and W is included as the element M, it is believed that the stabilizing effect of O2 type structure by the element M is obtained.

### 7. Summary

From the above examples, the positive electrode active material particles, (1) having O2 type structure, (2) including at least one element selected from Mn, Ni and Co; Li; element M; and O, (3) the element M being at least one selected from B, Mg, Al, K, Ca, Ti, V, Cr, Fe, Cu, Zn, Ga, Ge, Sr, Y, Zr, Nb, Mo and W, (4) the molar concentration of the element M in the surface layer portion of the particles being higher than the molar concentration of the element M in the central portion of the particles, can be said to be easy to achieve both high capacity and cycling properties.

### REFERENCE SIGNS LIST

1 Positive electrode active material particles
   1a surface layer portion
   1b central portion
10 Positive electrode
11 Positive electrode active material layer
12 Positive electrode current collector
20 Electrolyte layer
30 Negative electrode
31 Negative electrode active material layer
32 Negative electrode current collector
100 Lithium-ion secondary battery

1. Positive electrode active material particles,
having an O2-type structure,
comprising: at least one element selected from Mn, Ni and Co; Li; an element M; and O,
wherein
the element M is at least one selected from B, Mg, Al, K, Ca, Ti, V, Cr, Fe, Cu, Zn, Ga, Ge, Sr, Y, Zr, Nb, Mo and W, and
the molar concentration of the element M in the surface layer portion of the particles is higher than the molar concentration of the element M in the central portion of the particles.

2. The positive electrode active material particles according to claim 1, wherein
the chemical composition of the entire particles is represented by LiₐNa_{b}Mnₓ₋ₚNi_{y-q}Co_{z-r}M_{p+q+r}O₂ (wherein 0<a≤1.00, 0≤b≤0.20, x+y+z=1, and 0<p+q+r≤0.07).

3. The positive electrode active material particles according to claim 2, wherein
the chemical composition of the surface layer portion is represented by LiₐNa_{b}Mnₓ₋ₛNi_{y-t}Co_{z-u}Mₛ₊ₜ₊ᵤO₂ (wherein 0<a≤1.00, 0≤b≤0.20, x+y+z=1, and 0.08<s+t+u).

4. The positive electrode active material particles according to claim 3, wherein
the chemical composition of the central portion is represented by LiₐNa_{b}Mnₓ₋ₕNi_{y-i}Co_{z-j}Mₕ₊ᵢ₊ⱼO₂ (wherein 0<a≤1.00, 0≤b≤0.20, x+y+z=1, and 0≤h+i+j<0.07).

5. A manufacturing method of positive electrode active material particles, the method comprising:
obtaining Na containing transition-metal oxide particles having a P2 type structure; and
ion-exchanging at least a portion of Na of the Na containing transition metal oxide particles to Li, and doping at least one element M selected from B, Mg, Al, K, Ca, Ti, V, Cr, Fe, Cu, Zn, Ga, Ge, Sr, Y, Zr, Nb, Mo and W in the surface layer of the particle to obtain a Li containing transition-metal oxide particles having a O2 type structure.

6. The manufacturing method according to claim 5, the method comprising:
ion-exchanging at least a portion of Na of the Na containing transition-metal oxide particles to Li, and doping the element M in the surface layer of the particle, by contacting the particle with the salt containing Li and the element M.

7. The manufacturing method according to claim 6, wherein
the salt comprises Li, the element M and halogen.

8. The manufacturing method according to claim 5, wherein
the Na containing transition-metal oxide particles have a chemical composition shown as Na_{c}MnₓNi_{y}Co_{z}O₂ (wherein 0<c≤1.00 and x+y+z=1).

9. A lithium-ion secondary battery, comprising a positive electrode, an electrolyte layer and a negative electrode, wherein
the positive electrode includes the positive electrode active material particles according to claim 1.
